(19) United States
(12) Patent Application Publication
(10) Pub. No.: US 2017/0242965 A1
(43) Pub. Date: Aug. 24, 2017

(54) DYNAMIC INTERACTIVE PAIN MANAGEMENT SYSTEM AND METHODS

(71) Applicant: REWIRE LTD., Modiin (IL)

(72) Inventor: ELY SIMON, MODIIN (IL)

(21) Appl. No.: 15/440,133

(22) Filed: Feb. 23, 2017

Related U.S. Application Data
(60) Provisional application No. 62/299,030, filed on Feb. 24, 2016.

(51) Int. Cl. G06F 19/00

(52) U.S. Cl. CPC G06F 19/325; G06F 19/322; G06F 19/3456; G06F 19/3431

(57) ABSTRACT

An interactive pain diary for recording information about a pain episode during real-time includes a pain navigation system for navigating treatment options during the pain episode and records the information for future use. Sensors may be included to record the information, and collected data may be stored and used to update the pain navigation system and to inform a clinician.

### CROSS-REFERENCE TO RELATED APPLICATIONS

This application claims the benefit of priority from U.S. Provisional Patent Application No. 62/299,030, filed Feb. 24, 2016.

### BACKGROUND

Management of pain for individuals with chronic pain conditions typically involves patients completing paper diaries, or more recently mobile diaries that chronicle the pain episode duration, characteristics, and treatment, thereby providing the physician a documentation of pain history. While the physician may prescribe one or more prescription medications and the patient may additionally choose to use over-the-counter medications and alternative therapies, it is up to the patient to decide on the choice and timing of specific treatments at different decision points during the pain episode.

There is no current system that helps patients manage their prescribed therapies during acute pain episodes. Further, there are no tools to systematically help the patient cope with the fear and despair that commonly accompanies chronic pain conditions. In addition, compliance with and accuracy in filling out the diary in a consistent manner is low. Moreover, patient communication with medical professionals is limited to infrequent office visits. There are no current methods for obtaining advice or alerting a physician about the state of the patient.

### SUMMARY

There is provided, in accordance with embodiments of the present invention, a system for pain management. The system includes a mobile device having a user pain management system, and a pain episode navigation system for helping a user manage the pain event based recorded information from the user pain management system. The user pain management system includes a pain diary for recording information from a pain event, the pain diary having a user interface for providing the information from the pain event, a data input for collecting the provided information from the user interface, and an event recorder for recorded the collected information.

In accordance with further features of the invention, the system may further include a central server in communication with the mobile device, wherein the central server is configured to inform the pain episode navigation system and to store information from the pain diary. In yet additional features of the invention, the system may further include at least one sensor, wherein the data input is further configured for receiving information from the sensor during the pain event. The sensor may be, for example, a physiological sensor, or any other suitable type of sensor.

In accordance with further features of the invention, the pain diary may also include a pain episode navigation selector for selecting a type of pain episode navigation system, wherein the pain episode navigation system may include at least one of: a tele-coach, a live clinician, or an electronic pain episode navigation system. In accordance with further features in embodiments of the invention, the information provided by the user interface may include information about physical symptoms, emotional symptoms, pain ratings, medications taken, prodromal symptoms or other relevant data.

In accordance with yet additional features of the invention, the system may further include a local server having a clinician pain management system in communication with the central server, wherein the local server is configured to receive data from the pain diary and to provide additional data to the central server for informing the pain episode navigation system.

In accordance with yet additional features of the invention, the pain episode navigation system may include a pre-treatment component including a treatment plan receiver configured to receive treatment information and a treatment component for providing the received treatment information to the user via the mobile device, and for adjusting the received treatment information in real-time based on the recorded information from the pain diary. The pain episode navigation system may also include a post-treatment component for collecting information about effectiveness of the treatment provided by the treatment component.

In accordance with yet additional features of the invention, the system may also include a display for displaying recorded information. The display may include charts, graphs, or other depictions of the state of the user and may further include a composite score depicted over time.

In other aspects of the invention methods and computer program products embodying the invention are provided.

Unless otherwise defined, all technical and scientific terms used herein have the same meaning as commonly understood by one of ordinary skill in the art to which this invention belongs. Although methods and materials similar or equivalent to those described herein can be used in the practice or testing of the embodiments of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for pain management, constructed and operative in accordance with an embodiment of the invention;

FIG. 2 is a simplified conceptual illustration of a user pain management system from the system for pain management of FIG. 1, constructed and operative in accordance with embodiments of the present invention;

FIG. 3 is a simplified conceptual illustration of a clinician pain management system from the system for pain management of FIG. 1, constructed and operative in accordance with embodiments of the present invention;

FIG. 4 is a simplified conceptual illustration of a pain episode navigation system from the user pain management system of FIG. 2, constructed and operative in accordance with embodiments of the present invention;

FIG. 5 is a simplified flowchart illustration of an exemplary method of operation system for pain management in accordance with embodiments of the present invention;

FIGS. 6A and 6B are flowchart illustrations of examples of decision trees which may be used in a method for management of a pain episode in accordance with embodiments of the present invention;

FIG. 7 is a simplified block diagram illustration of an exemplary hardware implementation of a computing system, constructed and operative in accordance with an embodiment of the invention;

FIG. 8 is an illustration of a dashboard which may be used for display in the system of FIG. 1 in accordance with embodiments of the present invention; and

FIG. 9 is a graphical illustration of a health score, depicted over time, in accordance with embodiments of the present invention.

### DETAILED DESCRIPTION

The invention is directed to an integrated system involving both the patient and health care professionals aimed at decreasing suffering from chronic pain. This system goes beyond application of traditional disease management capabilities to the management of chronic pain conditions to empower the patient to better care for and cope with his/her acute pain episodes.

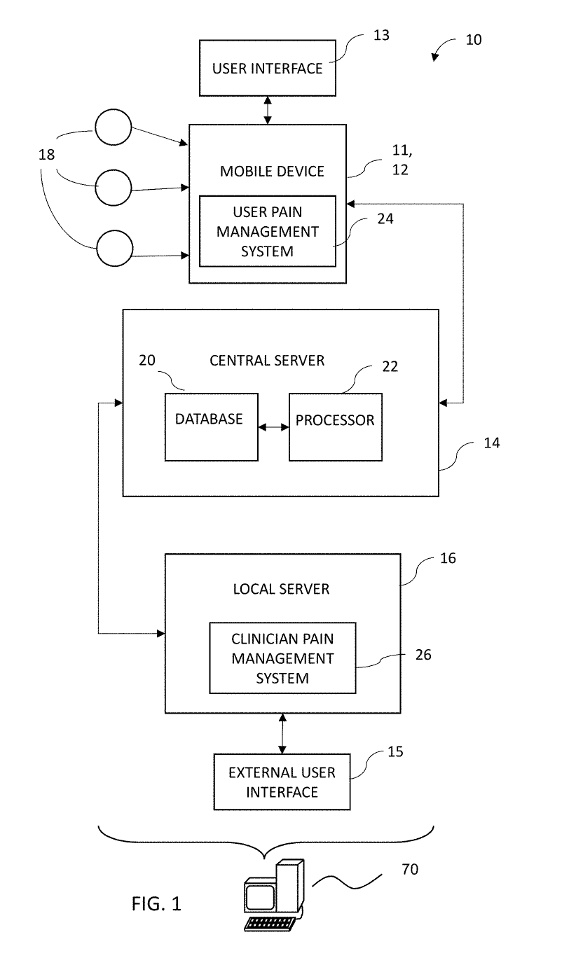

Reference is now made to FIG. 1, which is a simplified conceptual illustration of a system 10 for pain management constructed and operative in accordance with embodiments of the present invention. System 10 includes a device 11 which may be a stationary device or a mobile device 12, in communication with a central server 14, which in turn is in communication with a local server 16. For the purpose of simplification, device 11 will be referred to herein as a mobile device; however, it should be readily apparent that device 11 may be any suitable device. Mobile device 12 is configured to receive input from sensors 18, from a user via a user interface 13 and from central server 14. Central server 14 includes a database 20 for storing data and a processor 22 and is in two-way communication with both mobile device 12 and with local server 16. Local server 16 receives input from central server 14 and from an external user via an external user interface 15. Both mobile device 12 and local server 16 are configured to send output to central server 14, and can also communicate with one another through central server 14.

Mobile device 12 may be any computing device, such as a personal computer, laptop computer, smartphone, tablet computer, wrist watch computer, or any other computing device which may be carried from place to place. Mobile device 12 includes a user pain management system 24, which may be a computer program or application or an internet based system, which interfaces with the user via user interface 13, which may include touchscreen, keypad, microphone, sensors, or any other input method. User pain management system 24 is in communication with central server 14 so that any data received from the user via user interface 13 or via sensors 18 may be uploaded to central server 14 for further processing, and any relevant data from central server 14 may be communicated to user pain management system 24 and further communicated to the user via user interface 13 of mobile device 12 by visual display, sound output via speakers or earphones, vibration or any other means. User pain management system 24 may include multiple modules, which will be described in greater detail hereinbelow. Sensors 18 may be any sensors which are suitable for acquiring relevant data and may include, but are not limited to, a motion sensor, an electrodermal activity sensor, a heart rate and heart rate variability monitor, an electroencephalography (EEG) recording headset, EEG, pupil size measurement device, eye movement measurement device, a respiration monitor, a pulse oximeter, or an electromyography (EMG) recording device. In some embodiments, sensors 18 are included on a separate wearable device such as a wrist band, palm or finger electrodermal sensor, patch sensor, watch, headband, multi-electrode headset or other. Sensor data may include processing that extracts relevant information such as activity level, sleep duration, stress level, and early pain episode warning signals.

Local server 16 is located remotely from mobile device 12 and from central server 14 and may be, for example, a personal computer or laptop at a clinician's or physician's office or at a specialized health data monitoring center such as a pain helpline. Local server 16 includes a clinician pain management system 26, which may be a computer program or application or an internet based system, which interfaces with an external user, such as a clinician or other healthcare professional via external user interface 15. Clinician pain management system 26 is in communication with central server 14 so that any data received from the external user may be transmitted to central server 14 for further processing, and any relevant data from central server 14 may be communicated to clinician pain management system 26 and further communicated to the external user via external user interface 15. Since both user pain management system 24 and clinician pain management system 26 are in communication with central server 14, an external user, such as a clinician, may communicate with a user and vice versa through system 10.

Central server 14 includes a processor 22 for processing input received from user pain management system 24 and from clinician pain management system 26. Processor 22 is also configured to run algorithms and to activate relevant modules within user pain management system 24. Processor 22 may include standard data processing software, as well as machine learning algorithms for improving the process based on received data from either or both of user pain management system 24 and clinician pain management system 26 and from database 20. Processor 22 may also be configured for processing data stored on the “cloud”. Data received from user pain management system 24 and from clinician pain management system 26 may be stored in a database 20 in central server 14. Database 20 may also include external data from other sources, including general population data, data from research studies, etc., which can also contribute to the algorithms within processor 22.

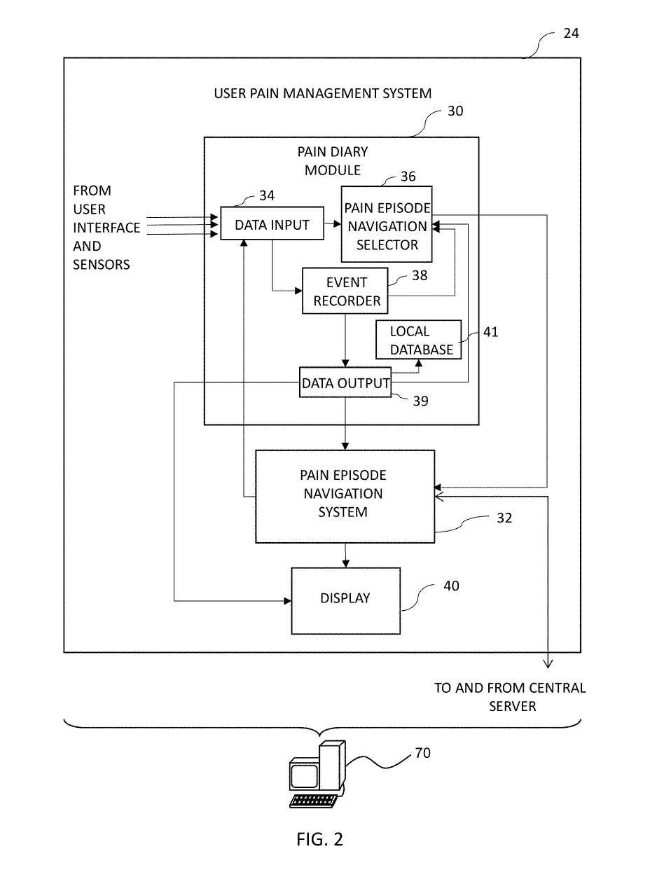

Reference is now made to FIG. 2, which is a simplified conceptual illustration of user pain management system 24, constructed and operative in accordance with embodiments of the present invention. User pain management system 24 includes a pain diary module 30, a pain episode navigation system 32, and a display 40. Pain diary module 30 is an interactive diary, and is configured to receive data from user interface 13, sensors 18, and from pain episode navigation system 32. Pain episode navigation system 32 is in electronic communication with central server 14, and as such, pain diary module 30 can receive data from or provide data to central server 14, including processor 22 and database 20. Pain diary module 30 includes a data input 34, a navigation selector 36, an event recorder 38 and a data output 39. Data from user interface 13, sensors 18 and pain episode navigation system 32 are received by data input 34. Thus, from the beginning of a pain event and throughout the duration of the pain event, data are collected, and may include direct input from the user, such as via voice, typing, swiping or any other input method, may further include various types of data from sensors 18, and may further include data from the pain episode navigation system 32 (such as, for example, recommended actions, actions taken, etc.). At some point during the pain event, the user may be prompted by navigation selector 36 to select the preferred type of assistance for navigating the pain event. Navigation selector 36 is configured to select one of available modes of assistance. The type of assistance available may be, for example, a tele-coach, wherein the user is connected via voice, video or other means to a live professional at a remote site. The professional may then coach the user throughout the pain episode, and help select a course of action in real time. This may be done, for example, via clinician pain management system 26, or via an alternative output program. Alternatively, the type of assistance may be delivered by a computer based system, such as a pain episode navigator 32, which will be described in further detail. In some embodiments, navigation selector 36 is a simple requester, wherein a request is prompted for a user to input a selection of either an electronic pain episode navigator or a tele-coach as the pain episode navigation system to be used. In other embodiments, navigation selector 36 is an automated selector, wherein the selection of the type of assistance to be used is based on preset preferences or data received from data input 34 or is based on availability or tele-coach services. For example, if the tele-coach system is not online at the time of the pain episode, the computerized version may be automatically selected. Alternatively, if data from data input 34 warrants that the computerized version is desirable in a particular case, it may be automatically chosen, with an option to override the automatic choice if the user so decides. Pain diary module 30 and pain episode navigation system 32 are interactively and iteratively operated, and all data from the pain episode is recorded by event recorder 38 and sent to data output 39. Data may also be sent to pain episode navigation selector 36 to help provide information for selecting the appropriate navigation tool, which may issue a new directive during the pain episode based on new data received. As a pain episode progresses, data output is sent to pain episode navigation system 32 and to a local database 41. Local database 41 holds relevant data for the individual user locally, but this information may also be stored on central database 20 and may be retrieved therefrom if needed. Data collected from pain episode navigation system 32 may be sent back into pain diary module 30 in an iterative process until the pain episode ends. Data from data output 39 and from pain episode navigation system 32 may be displayed on a display 40 for the user to see. Display 40 may be, for example, a chart or graph, and may include relevant information such as patient history, comparison with relevant population data, etc.

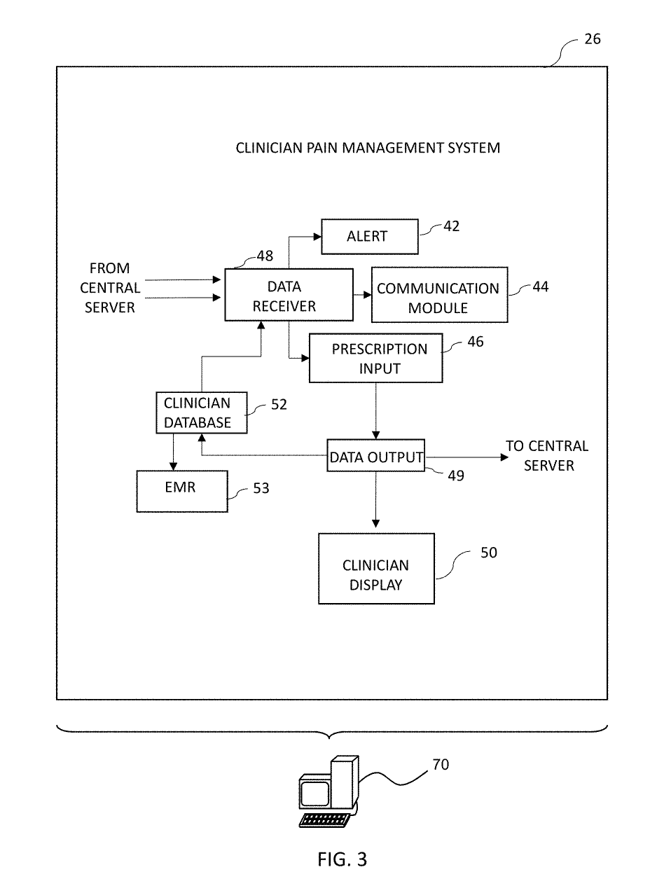

Reference is now made to FIG. 3, which is a simplified conceptual illustration of clinician pain management system 26 of system 10 depicted in FIG. 1, shown in greater detail constructed and operative in accordance with embodiments of the present invention. Clinician pain management system 26 is located on a local server at a clinician's office or may be located on a separate mobile device, for example. Clinician pain management system 26 may include an alert 42 for alerting the physician, nurse or other clinician that a pain episode is occurring, a communication module 44 for communicating with the patient via audio, video, textual or other means, a prescription input 46 for inputting prescription or other recommended treatment information, a data receiver 48 for receiving data from any or all of the following—the patient, a population database (i.e., from other patients in the system), and professional guidelines for best practices, which may help inform the clinician about how to proceed, and a clinician database 52 for storing information received from the patient and from population data (i.e., from other patients in the system). In embodiments of the invention, the clinician can communicate directly with the patient (through the central server) via communication module 44 when, for example, navigation selector 36 selects a tele-coach or if the clinician desires to initiate a consult, either on his/her own or following an alert. This can be done via text, voice, video conferencing, phone, mobile app, chat, email, etc. Communication may include triage (i.e., advising best point of care—at home, clinic, or emergency room, for example) as well as coaching during the attack itself. Communication module 44 can be activated at any point during the pain episode. The interactions between the clinician and the user may be recorded and saved in clinician database 52.

Alternatively, the clinician or the pain episode navigation selector 36 may activate pain episode navigation system 32, with pre-entered data from the clinician. In this case, the clinician may have already communicated with the particular patient (either at an in-person consult or via a virtual consult, for example) and can enter the prescription information for the individual patient via prescription input 46. The prescription information may include prescription medications, non-prescription medications, non-pharmacological treatments (such as biofeedback, relaxation, hypnosis, or others) along with indications for each of these treatments, dosages, frequency of administration, maximum allowable doses, drug interaction and contraindications, and conditional decision support information (such as, if there is vomiting, route the navigator to a treatment whose administration route is not oral). The prescription information may further include data from other patients of a similar sub-type (i.e. “patients like me”). This prescription information is stored in pain episode navigation system 32 of user pain management system 24 and may be used as a basis for advising the patient's treatment decisions in real time. The stored prescription information is comparable to a map on a GPS traffic navigation system, wherein the terrain of the treatment plan is clearly mapped out and implemented algorithmically as a decision tree or other suitable technique, whereby a pre-defined series of events, conditions, and associated decision points lead to alternative courses of action and recommendations based on rules. However, pain episode navigation system 32 is designed as a smart system, wherein during the course of a pain episode, it may be optimal to use one portion of the treatment plan over another, and navigating the course of the pain episode may change due to real-time circumstances. The conditions for changing the treatment plan or for choosing one course of action over another may be pre-programmed by the clinician in prescription input 46, or may be based on stored data (stored in pain episode navigation system 32) from accepted best practices and professional guidelines. For example, there may be a prescribed medication, but with rules and conditions such as: contraindications to a particular treatment plan (for example, suspected pregnancy or contraindications to medications taken already), limits to the number of times the particular medication may be used, etc. In some embodiments, the user may be directed to the alternate path via the tele-coach. Prescription input 46 sends all the prescription information to pain episode navigation system 32 via data output 49, (through central server 14). Data receiver 48 receives data from the patient during the pain episode—either during real time or after the event has occurred, and may be stored on clinician database 52. Clinician database 51 holds relevant data for the clinic for each user, but this information may also be stored on central database 20 and may be retrieved therefrom if needed. Received data may be useful for informing a recommended course of action in real time or for the next episode, and clinician database 52 may upload the data to electronic medical records (EMR) 53 for the patient. Any updates to the prescription or to the parameters for determining the course of action may then be input into prescription input 46 and sent to pain episode navigation system 32 via central server 14 for future use. These data can be used by processor 22 to improve the overall performance of system 10 by adapting the rule-base of the pain episode navigation system 32 by learning from the past history of pain episodes via a machine learning technique such as neural networks or any other appropriate algorithm.

Clinician pain management system 26 further includes a clinician display 50. Clinician display 50 may include a control panel to aggregate and easily access data from all of its patients enrolled in the system, and to provide alerts. Further, clinician display 50 may include an interface to query the data from a specific patient or from a subset of patients represented in the control panel.

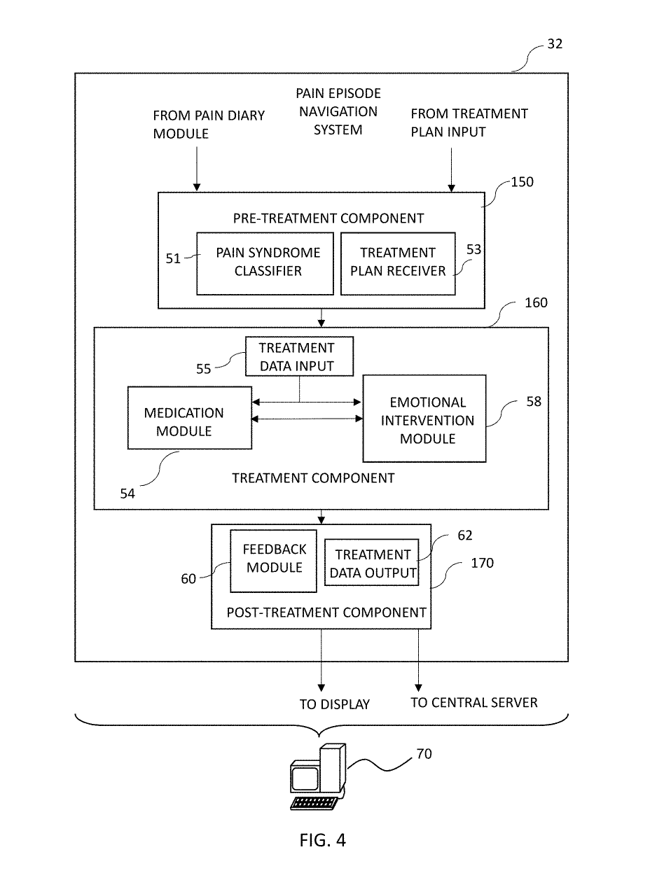

Returning now to user pain management system 24, reference is now made to FIG. 4, which is a simplified conceptual illustration of pain episode navigation system 32, constructed and operative in accordance with embodiments of the present invention. In the embodiment shown herein, pain episode navigation system 32 is an electronic pain episode navigation system, which includes a pre-treatment component 150, a treatment component 160 and a post-treatment component 170. Pre-treatment component 150 includes, for example, a pain syndrome classifier 51 to classify the type of pain being experienced. For example, in the case of a headache, pain syndrome classifier 51 may use data received from the pain diary module 30 to determine what type of headache is being experienced and may be even more specific to specify the stage of the headache. For example, in the case of a migraine, a classification can be made based on a decision tree or similar algorithm configured from the diagnostic manual of the International Headache Society, known as the International Classification of Headache Disorders (ICHD). Pre-treatment component 150 may further include a treatment plan receiver 53 for receiving prescription or other treatment information from the clinician via treatment plan input 46. In some embodiments, prescription information is input by the user through the pain diary module following a consult with the clinician, for example. Pre-treatment component 150 is designed to orient the system to the type of pain syndrome and to any prescribed treatment plans, including those chosen by the user other than those prescribed by the healthcare provider. In some embodiments, data for multiple pain syndromes may be available, with specific treatment plans for each syndrome. Treatment component 160 includes the prescribed treatment plan, along with any rules and conditions that may apply. Treatment component may include, but is not limited to: a medication module 54, and an emotional intervention module 58, which will be described in greater detail hereinbelow. Once the treatment component is finished, or at various times during the treatment, post-treatment component 170 may be activated. Modules which may be activated as part of post-treatment component 170 may include, but are not limited to: a post-treatment feedback module 60 and a treatment data output 62. All data from feedback module 60 and treatment data output 62 may be sent to display 40 of user pain management program 24, and/or to central server to be stored in the central database 20, processed by processor 22 and/or forwarded to clinician pain management program 26. It should be readily apparent that the invention is not limited to the modules disclosed herein, and that other modules may be included as well.

Any of the elements shown in FIGS. 1, 2, 3 and 4 are preferably implemented by one or more computers in computer hardware and/or in computer software embodied in a non-transitory, computer-readable medium in accordance with conventional techniques, such as where any of the elements shown in FIGS. 1, 2, 3 and 4 are hosted by a computer 70.

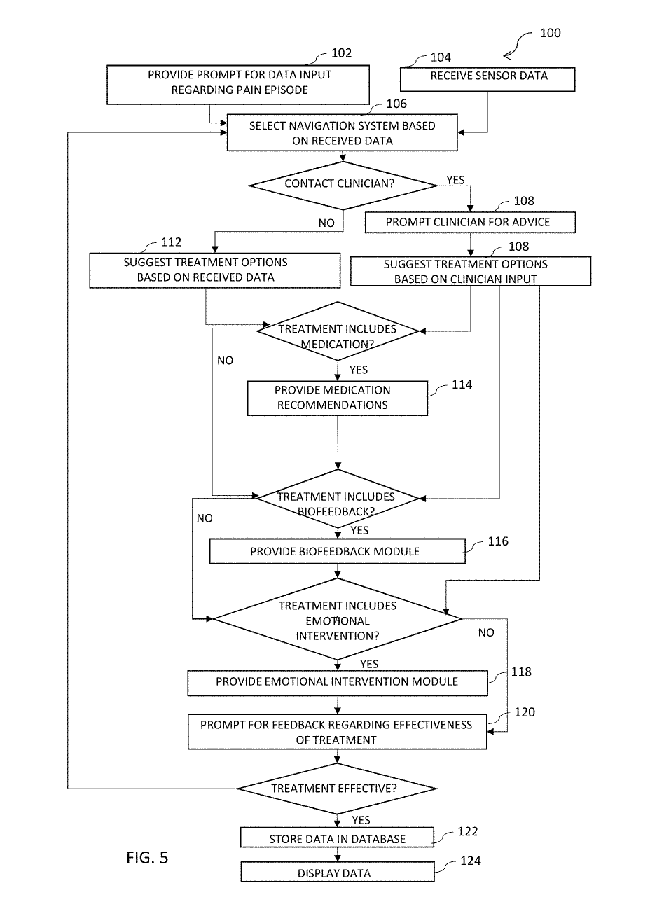

Reference is now made to FIG. 5, which is a flowchart diagram illustration of a method 100 of pain management in accordance with embodiments of the present invention. System 10 of FIG. 1 is configured to perform the steps of method 100.

At the beginning of a pain episode, in one embodiment, the user activates user pain management system 24 either by touch, voice or some other method. In other embodiments, sensors 18 sense a change in the physiological parameters of the user and transmit data regarding these parameters to system 10, thus activating system 10. When activated, either by the user or by sensors 18, system 10 provides pain diary module 30 to the user. Pain diary module 30 begins with a prompt (step 102) for information regarding the pain episode. The prompt may be made by audio, video, text or any other method. Information requested may include, for example, but is not limited to, information regarding symptoms, pain ratings, medications taken if any, etc. In some embodiments, pain may be preceded by prodromal or premonitory symptoms such as irritability, excessive hunger or thirst, sleepiness, hyperactivity, mood changes, or increased frequency of urination. In the case of migraine, the pain may be preceded by an aura, which may involve visual phenomena such as blind spots or bright lights, but may also involve sounds, smells, limb weakness or complex perceptual distortions. Pain symptoms may also be accompanied by emotional symptoms, such as anxiety, panic, depressed mood, or obsessive thoughts. In the case of migraine, accompanying symptoms may include photophobia, phonophobia, lightheadedness, or nausea, for example. Any or all of these symptoms are recorded and may sometimes be used to activate system 10.

System 10 may also receive (step 104) data from one or more sensors 18. Sensors 18 may include, but are not limited to a motion sensor, an electrodermal activity sensor, a heart rate and heart rate variability monitor, an electroencephalography (EEG) recording headset, a respiration monitor, a pulse oximeter, or an electromyography (EMG) recording device. Processor 22 of central server 14 processes all of the received data, including responses to the questions and any additional data received from sensors 18. Processor 22 then assigns (step 106) a pain episode navigation system to use based on the received data.

Processor 22 uses this data to decide whether or not to contact a clinician or clinical help line service. The clinician may be the user's doctor, nurse, nurse practitioner, physician's assistant, therapist or other professional, or it may be an outside clinician or help line service that the user does not personally know. In some embodiments, a group of on-call health care providers may be specifically designated for the program. If the decision is to contact the clinician, system 10 prompts (step 108) the clinician for advice via clinician pain management system 26, located on local server 16. The clinician can then input advice, verbally or through touch or any other accepted method, and system 10 then suggests (step 110) treatment based on this advice. Such advice may be given synchronously (at the time of the inquiry) or asynchronously (after the time of the inquiry). The suggestions may be a recording or a live feed of the clinician talking, or it may be via video or chat interfaces, for example. If the decision is not to contact the clinician, processor 22 activates pain episode navigation system 32, using the pre-prescribed data and the data received from the user and/or the sensors, via treatment data input 55. System 10 suggests (step 112) treatment based on this process. It should be readily apparent that the step of suggesting (step 112) treatment may be repeated as necessary throughout the process.

If the suggested treatment includes medication, then medication module 54 is activated. Medication module 54 provides (step 114) recommendations for which prescribed or non-prescription medication to take, including doses, timing, etc.

If the suggested treatment includes emotional intervention, then emotional intervention module 58 is activated (step 118). Emotional intervention module 58 may include, for example, an acute episode positive emotional driver with systematic presentation of patient-specific stimuli that are linked to positive emotional states, relaxation, or stress relief. These may include music, pictures, videos, pre-recorded meditation, pre-recorded hypnosis, and computer games, all pre-loaded based on personal preferences, and aimed to distract the patient from the acute pain and to facilitate more positive emotions. The emotional intervention module may further include feedback of real-time measures of emotional stress. The sequence of specific stimuli will be guided by a real-time measurement of emotional state, as measured by accepted scientific measures of the level of arousal of the autonomic nervous system, namely pulse rate variability, electrodermal activity, voice stress measurement and other appropriate measures. These measures will also be displayed on the patient's display 40.

It should be readily apparent that the order of presentation of each of the treatment modules may be varied, and may depend on the individual circumstances. Moreover, additional treatment modules may be included, such as hypnosis or biofeedback, for example.

Once the suggested treatment is completed, post-treatment component 170 is activated. In the post-treatment component 170, system 10 prompts (step 120) the user for feedback regarding the effectiveness of the treatment. In some embodiments, data is also received from sensors 18 which may provide useful information about efficacy of the treatment. The treatment efficacy data from the entire process is stored (step 122) in database 20 for future reference. If the treatment was not satisfactory, then system 10 reverts back to pre-treatment component 150 with a new attempt to help the user during the acute pain episode. When the process is finished all data regarding the process is stored (step 122) in database 20 and may be further passed along to the clinician via clinician management pain program 26. The clinician may save the data in clinician database, which may include an electronic medical record (EMR) as described above.

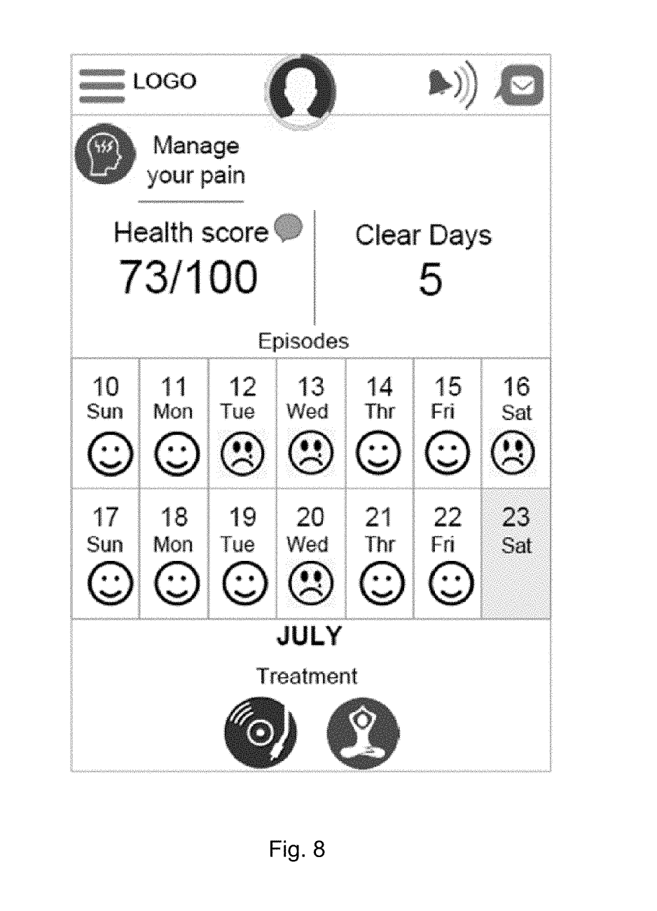

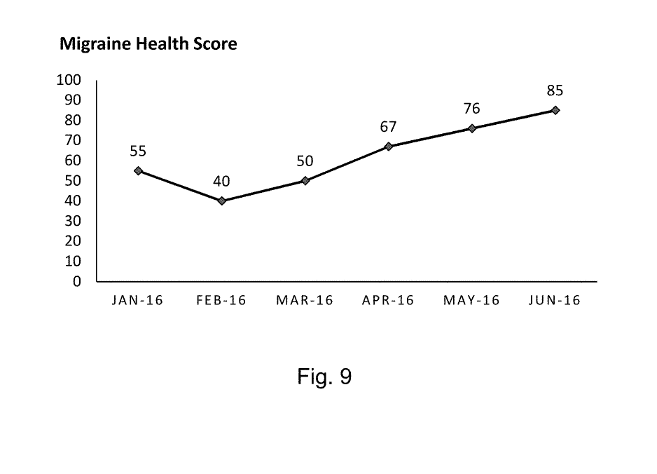

System 10 further displays (step 124) data regarding the pain episode. Display may be in the form of a dashboard or report, for example. An example of a dashboard is shown in FIG. 8, including a visual display of the current and/or prior state of the user. The dashboard may include options for treatment, audio instructions, a calendar, a health score, or other relevant features. There may also be reports generated, and in some embodiments there may be separate reports generated for the patient and for the clinician. Patient display may include data regarding the current episode, comparisons to past episodes and to other population data for similar circumstances. The patient display may include a display of historical pain episodes, with time-based trends and tracking of key pain characteristics and triggers. In addition, the patient display may include a score which can be tracked over time, and a graphical display of the score over time. In one embodiment of the present invention, a composite score which combines multiple recorded data points over a past period of time is used. For example, as shown in FIG. 8, a “migraine health score” may be a composite of a number of headache days per month (25% of the composite score), intensity of the headache (25% of the composite score), and activity level (50% of the composite score), wherein the scores are displayed on a normalized scale. For example, a scale of 0-100 may be used, where higher numbers indicate better migraine health. The migraine health score may then be displayed over time, so that the user can obtain a picture of his or her overall migraine health over time. It should be readily apparent that the composite score may be composed of different parameters than the ones listed here and in different percentages than the ones listed here.

Clinician display may include, for example, a clinic report summarizing the current episode, including effectiveness of medications and course of symptoms, a clinic dashboard for individual patient history, a clinic control panel for all patients in the system, and automatic or prompted EMR data synching. The clinic dashboards (individual or for all patients) allow for flexibility in presenting data in clinically relevant ways, and can be tailored for clinician's preferences. There also may be provided the ability to query data. Moreover, the control panel for all patients may include means for prioritizing patients for communication and clinic visits based on diary data or patient requests. Clinician display may also include a score which can be tracked over time, and a graphical display of the score over time such as the “migraine health score” as described above with reference to the patient report and FIG. 8.

### Examples

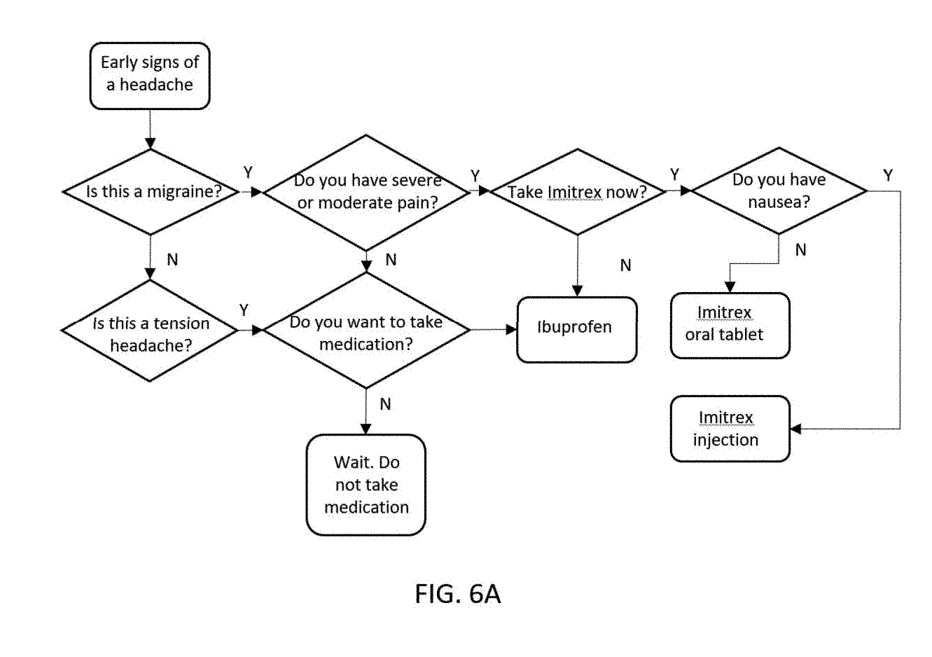

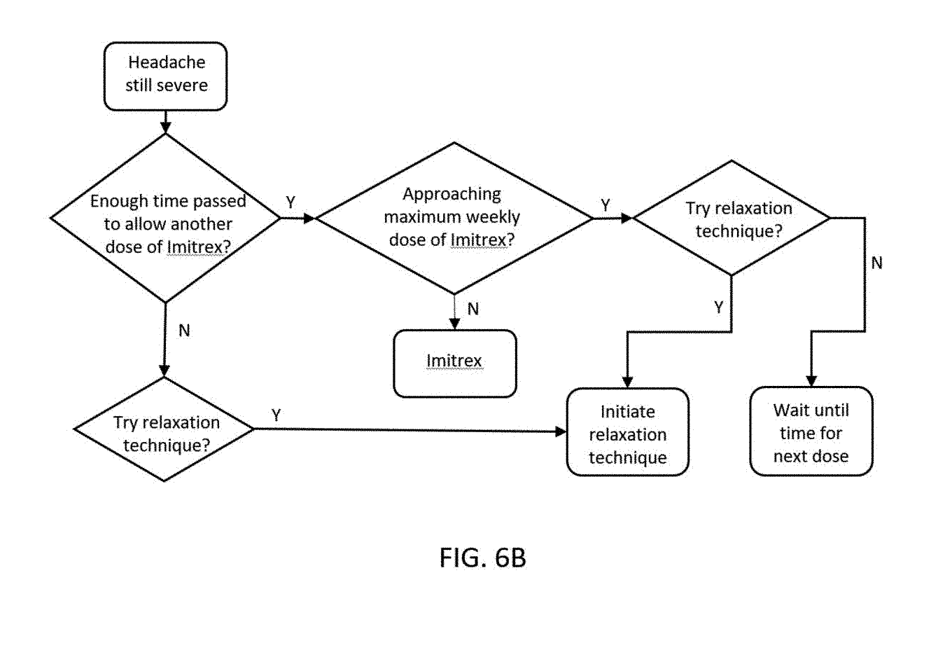

Reference is now made to FIGS. 6A and 6B, which are two non-limiting examples of decision trees which may be used in a method for management of a pain episode in accordance with embodiments of the present invention. As seen in FIG. 6A, the system may prompt the user for information which can help classify the headache as a migraine or a tension headache. Depending on the classification, the user will be guided further. For example, if the headache is classified as a tension headache, the user will be asked if he/she would like to take medication. If so, the system will recommend a medication and an amount. If not, the user will be told to wait it out or be given some other instruction. If the headache is classified as a migraine, the user will be asked to rate its severity. If the severity is low, the user will be asked for his/her preference regarding taking medication. If the severity is moderate or high, the user will be prompted to take a stronger medication, such as SUMATRIPTAN (IMITREX). Since there are different forms of this medication, the user will be asked if there is nausea. If there is, he/she will be prompted to take the injection version. If not, he/she will be prompted to take the oral version. In another non-limiting example, as shown in FIG. 6B, the user may decide to reengage the system because the headache is still severe. The system will ask how much time has passed since the last dose of medication was taken. Alternatively, this information may be available if it was input by the user when he/she last took the medication. If the amount of time since the last dose is not sufficient for an additional dose, the user may be asked if he would like to try a relaxation technique. If yes, the system will provide a technique. If not, the user will be asked to wait until the next dose can be taken. If the amount of time since the last dose was taken is sufficient to take an additional dose, the system may then check whether the weekly maximum dose of medication has already been reached. If yes, the user may be prompted to try an alternative method, such as a relaxation technique. If not, the user may be prompted to take another dose. Thus, the system is interactive and dynamic and may be modified in accordance with patient-specific data, population data, patient preferences or other factors. The system and method described herein thus offers an advanced e-diary technology, whereby events are recorded in real-time, thus providing a lower barrier to use of the diary. Since it is interactive, as it is helping the patient navigate the acute pain, it is also simultaneously recording the event. Moreover, the system and method described herein provides additional functionality of providing the patient with personalized advice for treatment management during pain attack using electronic program. A self-learning algorithm based on the patient's own history during pain episodes provides for advanced care. In some embodiments, a tele-coach module allows for effective communication between patients and caregivers, including an alert system for the clinic so they can proactively contact the patient. The present invention also provides for a voice-activated system to make it easier to use, and less difficult to access in the middle of a pain episode.

It should be readily apparent that during the entire process, the treatment plan is dynamic and furthermore, the system is designed to learn from previous outcomes. Moreover, the patient is coached through the pain episode, and is simultaneously collecting data for the pain diary. The clinician or caregiver benefits as well from organized data and smart guidance for the patient.

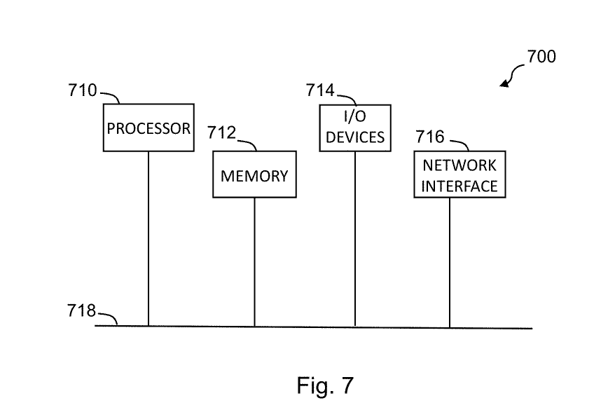

Referring now to FIG. 7, block diagram 700 illustrates an exemplary hardware implementation of a computing system in accordance with which one or more components/methodologies of the invention (e.g., components/methodologies described in the context of FIGS. 1-6) may be implemented, according to an embodiment of the invention. As shown, the invention may be implemented in accordance with a processor 710, a memory 712, I/O devices 714, and a network interface 716, coupled via a computer bus 718 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system for pain management, the system comprising:
a mobile device having a user pain management system, said user pain management system comprising:
a pain diary for recording information from a pain event, the pain diary including a user interface for providing the information from the pain event; a data input for collecting the provided information from the user interface; and an event recorder for recorded the collected information; and
a pain episode navigation system for helping a user manage the pain event based on the recorded information.

2. The system of claim 1, further comprising:
a central server in communication with the mobile device, wherein the central server is configured to inform the pain episode navigation system and to store information from the pain diary.

3. The system of claim 1, further comprising at least one sensor, wherein the data input is further configured for receiving information from the at least one sensor during the pain event.

4. The system of claim 3, wherein the at least one sensor is a physiological sensor.

5. The system of claim 1, wherein the pain diary further comprises:
a pain episode navigation selector for selecting a type of pain episode navigation system, wherein the pain episode navigation system may include at least one of: a tele-coach, a live clinician, or an electronic pain episode navigation system.

6. The system of claim 1, wherein the information provided via the user interface includes information about at least one of: physical symptoms, emotional symptoms, pain ratings, medications taken, or prodromal symptoms.

7. The system of claim 2, further comprising: a local server having a clinician pain management system in communication with the central server, wherein the local server is configured to receive data from the pain diary and to provide additional data to the central server for informing the pain episode navigation system.

8. The system of claim 1, wherein the pain episode navigation system comprises:
a pre-treatment component including a treatment plan receiver configured to receive treatment information; and
a treatment component for providing the received treatment information to the user via the mobile device, and for adjusting the received treatment information in real-time based on the recorded information from the pain diary.

9. The system of claim 8, wherein the pain episode navigation system further comprises a post-treatment component for collecting information about effectiveness of the treatment provided by the treatment component.

10. The system of claim 1, further comprising a display for displaying recorded information, wherein the display includes a composite score depicted over time.

11. A method for pain management, the method comprising:
recording data from a user during a pain episode;
providing a treatment plan for the user;
navigating the provided treatment plan during real-time via a computerized system, wherein the navigating is done based on the recorded data during the pain episode.

12. The method of claim 11, wherein said recording is done via at least one sensor.

13. The method of claim 11, wherein said providing a treatment plan includes providing at least one of: emotional intervention, or biofeedback.

14. The method of claim 11, wherein said providing a treatment plan includes providing a treatment plan prescribed by a clinician, and wherein said navigating comprises helping the user decide whether and when to implement different aspects of the treatment plan provided by the clinician.

15. The method of claim 11, further comprising collecting feedback from the user regarding the provided treatment plan after the pain episode, and updating the treatment plan for further pain episodes based on the collected feedback.

16. A computer program product for pain management, the product comprising:
an interactive pain diary for recording information from a pain event, the pain diary including a user interface for providing the information from the pain event; a data input for collecting the provided information from the user interface; and an event recorder for recorded the collected information; and
a pain episode navigation system for helping a user manage the pain event based on the recorded information,
wherein the interactive pain diary and the pain episode navigation system are provided on a mobile device.

17. The computer program product of claim 16, wherein the mobile device is in communication with a central server configured to inform the pain episode navigation system and to store information from the pain diary.

18. The computer program product of claim 16, wherein the interactive pain diary is configured to record data from at least one sensor during the pain event.

19. The computer program product of claim 16, wherein the pain diary further comprises:
a pain episode navigation selector for selecting a type of pain episode navigation system, wherein the pain episode navigation system may include at least one of: a tele-coach, a live clinician, or an electronic pain episode navigation system.

20. The computer program product of claim 17, further comprising a local server having a clinician pain management system in communication with the central server, wherein the local server is configured to receive data from the pain diary and to provide additional data to the central server for informing the pain episode navigation system.
